(19) United States
(12) Patent Application Publication
(10) Pub. No.: US 2026/0131679 A1
(43) Pub. Date: May 14, 2026

(54) ELECTRIFIED VEHICLE AND CONTOL METHOD THEREOF

(71) Applicants: Hyundai Motor Company, Seoul (KR); Kia Corporation, Seoul (KR)

(72) Inventors: Jee Heon Kim, Hwaseong-si (KR); Sung Uk Park, Hwaseong-si (KR); Ji Hye Son, Hwaseong-si (KR)

(21) Appl. No.: 19/075,132

(22) Filed: Mar. 10, 2025

(30) Foreign Application Priority Data
Nov. 13, 2024 (KR) 10-2024-0160662

(51) Int. Cl. B60L 53/20; B60L 53/16; B60L 55/00; H02J 7/00; H02J 7/06; H02M 1/14; H02M 1/42; H02M 1/44; H02M 3/00; H02M 3/335

(52) U.S. Cl. CPC B60L 53/20; B60L 53/16; B60L 55/00; H02J 7/06; H02J 7/855; H02M 1/14; H02M 1/4233; H02M 1/44; H02M 3/01; H02M 3/33573; H02M 3/33584; H02M 3/33592; B60L 2210/10; B60L 2210/30; H02J 2105/12

(57) ABSTRACT

In a vehicle, such as an electric vehicle, and a control method thereof, the vehicle can include a battery, a DC charging/discharging terminal and an AC charging/discharging terminal configured to be electrically connected to an external device, a motor drive system including a drive motor and an inverter, a bidirectional power exchange device configured to be selectively connected to the DC charging/discharging terminal or the AC charging/discharging terminal, and configured to perform bidirectional voltage conversion control for power exchange between the connected terminal and the battery, and a controller configured to perform, in response to the connected external device using DC power, power exchange between the connected external device and the battery through the motor drive system or power exchange between the connected external device and the battery through the bidirectional power exchange device, based on a result of communication with the connected external device.

### CROSS-REFERENCE TO RELATED APPLICATIONS

The present application claims priority to Korean Patent Application No. 10-2024-0160662, filed Nov. 13, 2024, the entire contents of which is incorporated herein for all purposes by this reference.

### TECHNICAL FIELD

The present disclosure relates to an electrified vehicle capable of efficiently charging and discharging a battery through a Vehicle-to-Home (V2H) device that uses DC power, and to a control method thereof.

### BACKGROUND

Recently, with growing interest in the environment, eco-friendly vehicles that have an electric motor as a power source are increasing. Eco-friendly vehicles are also referred to as electrified vehicles, and a representative example thereof is an electric vehicle (EV).

An electrified vehicle may be provided with a bidirectional power exchange device (or on-board charger, OBC) that charges a battery using grid power. Generally, an OBC is composed of a power factor correction circuit (PFC) that converts external AC voltage into DC voltage and a DC-DC converter that adjusts the converted DC voltage to a voltage required by the battery.

A vehicle-to-home (V2H) system, which enables power exchange between an electrified vehicle and a home based on the power exchange technology of the electrified vehicle is attracting attention. A V2H device that converts and exchanges power between the electrified vehicle and the home may be connected to the vehicle to enable bidirectional power exchange of the V2H system.

The foregoing is intended merely to aid in the understanding of the background of the present disclosure, and is not intended to mean that the present disclosure falls within the purview of the related art that is already publicly known, available, or in use.

### SUMMARY

Accordingly, an embodiment of the present disclosure has been developed keeping in mind the above problems occurring in the related art, and an embodiment of the present disclosure can provide an electrified vehicle capable of converting DC power between an external device and the electrified vehicle based on the configuration of a bidirectional power exchange device when a V2H device using DC power is connected, and/or can provide a control method thereof.

An embodiment of the present disclosure can provide an electrified vehicle having increased power conversion efficiency when a V2H device using DC power is connected, and/or can provide a control method thereof.

Advantages of the present disclosure are not necessarily limited to those mentioned above, and other advantages not mentioned can be understood by those skilled in the art from the description provided hereinafter.

According to an embodiment of the present disclosure, an electrified vehicle can include: a battery; a DC charging/discharging terminal and an AC charging/discharging terminal configured to be electrically connected to an external device; a motor drive system including a drive motor and an inverter; a bidirectional power exchange device configured to be selectively connected to the DC charging/discharging terminal and the AC charging/discharging terminal and configured to perform bidirectional voltage conversion control for power exchange between the connected charging/discharging terminal and the battery; and a controller configured to perform, when an external device using DC power is connected to the DC charging/discharging terminal, power exchange between the connected external device and the battery through the motor drive system or power exchange between the connected external device and the battery through the bidirectional power exchange device, based on a result of communication with the connected external device.

According to an embodiment, the bidirectional power exchange device may include: a power factor correction circuit including a plurality of switches; and a DC-DC converter including a plurality of switches.

According to an embodiment, the controller may perform the power exchange between the external device and the battery through the bidirectional power exchange device in such a manner that, when power is applied to the battery from the external device, the controller can control the power factor correction circuit based on a boost converter topology that boosts a voltage of power applied from the external device, and when power is applied from the battery to the external device, the controller can control the power factor correction circuit based on a buck converter topology that lowers a voltage of power applied from the battery.

According to an embodiment, the DC-DC converter may be a bidirectional LLC resonant converter.

According to an embodiment, when the external device is connected to the AC charging/discharging terminal and AC power is applied from the external device to the battery, the controller may control the power factor correction circuit to convert the applied AC power into DC power, and when the external device is connected to the AC charging/discharging terminal and power is applied from the battery to the external device, the controller may control the power factor correction circuit to convert DC power applied from the battery into AC power.

According to an embodiment, when the external device is connected to the AC charging/discharging terminal, the controller may control the power factor correction circuit based on a totem pole topology or a push-pull topology.

According to an embodiment, when the power exchange between the connected external device and the battery is performed through the motor drive system, the controller may keep the bidirectional power exchange device in an off state.

According to an embodiment, when the power exchange between the connected external device and the battery is performed through the bidirectional power exchange device, the controller may keep the inverter of the motor drive system in an off state.

According to an embodiment, when it is determined that the connected external device is a V2H device as the result of communication, the controller may perform the power exchange between the connected external device and the battery through the bidirectional power exchange device.

According to an embodiment, the DC charging/discharging terminal may include a busbar configured to connect the DC charging/discharging terminal and the bidirectional power exchange device to each other.

According to an embodiment of the present disclosure, a control method of an electrified vehicle can include: determining whether an external device using DC power is connected to a DC charging/discharging terminal among the DC charging/discharging terminal and an AC charging/discharging terminal that are configured to be electrically connected to the external device; communicating, by the controller, with the connected external device when the external device is connected to the DC charging/discharging terminal; and performing, by the controller, power exchange between the connected external device and the battery through a motor drive system or power exchange between the connected external device and the battery through a bidirectional power exchange device, based on a result of communication with the connected external device.

According to an embodiment, the bidirectional power exchange device may include: a power factor correction circuit including a plurality of switches; and a DC-DC converter including a plurality of switches.

According to an embodiment, in the performing of the power exchange between the connected external device and the battery through the bidirectional power exchange device, when power is applied to the battery from the external device, the controller may control the power factor correction circuit based on a boost converter topology that boosts a voltage of power applied from the external device, and when power is applied from the battery to the external device, the controller may control the power factor correction circuit based on a buck converter topology that lowers a voltage of power applied from the battery.

According to an embodiment, the DC-DC converter may be a bidirectional LLC resonant converter.

According to an embodiment, the control method may further include: determining whether the external device is connected to the AC charging/discharging terminal; and performing, by the controller, AC power exchange between the external device and the battery through the bidirectional power exchange device based on the result of communication with the external device. In the performing of the AC power exchange between the external device and the battery, when AC power is applied from the external device to the battery through the AC charging/discharging terminal, the controller may control the power factor correction circuit to convert the applied AC power into DC power, and when power is applied from the battery to the external device, the controller may control the power factor correction circuit to convert DC power applied from the battery into AC power.

According to an embodiment, the performing of the AC power exchange between the external device and the battery may include controlling, by the controller, the power factor correction circuit based on a totem pole topology or a push-pull topology.

According to an embodiment, the performing of the power exchange between the connected external device and the battery through the motor drive system may further include keeping, by the controller, the bidirectional power exchange device in an off state.

According to an embodiment, the performing of the power exchange between the connected external device and the battery through the bidirectional power exchange device may further include keeping, by the controller, an inverter of the motor drive system in an off state.

According to an embodiment, when it is determined that the connected external device is a V2H device as the result of the communication, the controller may perform the power exchange between the connected external device and the battery through the bidirectional power exchange device.

According to an embodiment, the DC charging/discharging terminal may include a busbar configured to connect the DC charging/discharging terminal and the bidirectional power exchange device to each other.

According to the electrified vehicle and/or the control method thereof according to various embodiments of the present disclosure as described above, it can be possible to perform power conversion based on the configuration of the bidirectional power exchange device when the V2H device using DC power is connected.

Using an embodiment of the present disclosure, it can be possible to achieve increased power conversion efficiency when the V2H device using DC power is connected.

The effects of the present disclosure are not limited to those mentioned above, and other effects not mentioned will be clearly understood by those skilled in the art from the description provided hereinafter.

### BRIEF DESCRIPTION OF THE DRAWINGS

The above and other features and other advantages of embodiments of the present disclosure can be more clearly understood from the following detailed description when taken in conjunction with the accompanying drawings, in which:

FIG. 1 is a schematic of an electrified vehicle according to an embodiment of the present disclosure;

FIG. 2 is a view illustrating a process of transmitting a signal when a V2H device using DC power is connected to a DC terminal, according to an embodiment of the present disclosure;

FIGS. 3 and 4 are views illustrating a bidirectional power exchange device according to an embodiment of the present disclosure;

FIGS. 5 to 7 are graphs illustrating PWM signals, output voltage, and output power outputted by a third switch and a sixth switch during second mode DC power exchange according to an embodiment of the present disclosure; and

FIG. 8 is a flowchart illustrating a process of controlling an electrified vehicle according to an embodiment of the present disclosure.

### DETAILED DESCRIPTION OF ILLUSTRATIVE EMBODIMENTS

Specific structural and functional descriptions of example embodiments of the present disclosure disclosed herein are for illustrative purposes of the example embodiments of the present disclosure. An embodiment of the present disclosure may be embodied in many different forms without departing from the spirit and significant characteristics of the present disclosure.

An embodiment of the present disclosure may be modified in various ways and implemented by various embodiments, so that specific example embodiments are shown in the drawings and will be described in detail. However, it can be understood that the present disclosure is not necessarily limited to the specific example embodiments, and an embodiment can include modifications, equivalents, and substitutions included in the spirit and the scopes of the present disclosure.

Unless otherwise defined, terms including technical and scientific terms used herein can have same meanings as commonly understood by one of ordinary skill in the art to which the present disclosure belongs. It can be understood that terms defined by a dictionary can be identical with meanings within the context of the related art, and they should not be ideally or excessively formally defined unless the context clearly dictates otherwise in this specification.

Hereinafter, example embodiments disclosed in the present disclosure will be described in detail with reference to the accompanying drawings, in which identical or similar constituent elements can be given same reference numerals regardless of the reference numerals of the drawings, and repeated description thereof can be omitted.

In the description of the following example embodiments, when a parameter is referred to as being “predetermined”, it may indicate that a value of the parameter is determined in advance when the parameter is used in a process or an algorithm, the value of the parameter may be set when the process or the algorithm starts, or may be set during a period that the process or the algorithm is executed.

In the description of the present disclosure, when it is determined that the detailed description of the related art may obscure the gist of the present disclosure, detailed description thereof can be omitted. The accompanying drawings are used to help easily understand the technical ideas of the present disclosure and it can be understood that the ideas of the present disclosure are not necessarily limited by the accompanying drawings. The ideas of the present disclosure can be construed to extend to modifications, equivalents, and substitutes besides the accompanying drawings.

It can be understood that, although the terms “first”, “second”, etc., may be used herein to describe various elements, these elements should not be necessarily limited by these terms. These terms can be used merely to distinguish one element from another element.

It can be understood that when an element is referred to as being “connected” or “linked” to another element, it can be directly connected or linked to the other element or intervening elements may be present therebetween. In contrast, it can be understood that when an element is referred to as being “directly connected” or “directly linked” to another element, there are no intervening elements present.

As used herein, singular forms can be intended to include the plural forms as well, unless the context clearly indicates otherwise.

It can be further understood that the terms “comprise”, “include”, “have”, etc., when used in this specification, specify the presence of stated features, integers, steps, operations, elements, components, and/or combinations thereof, but do not preclude the presence or addition of one or more other features, integers, steps, operations, elements, components, and/or combinations thereof.

A unit or control unit included in names such as a motor control unit (MCU) and a hybrid control unit (HCU) is a term widely used in the industry for naming a controller that controls a specific vehicle function, but does not mean a generic function unit.

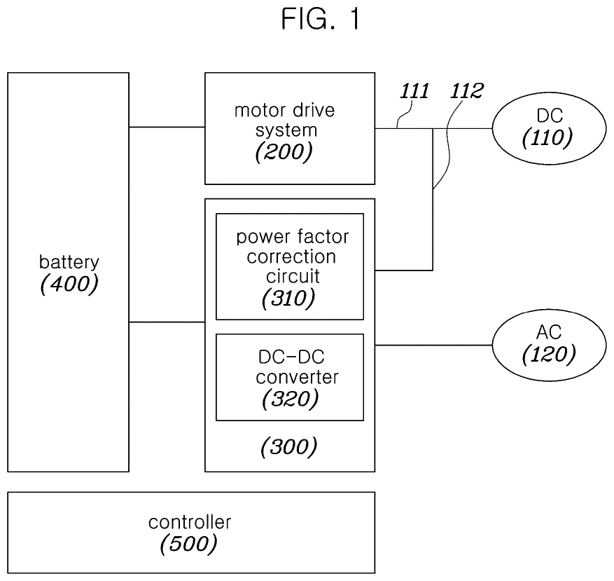

FIG. 1 is an electrified vehicle according to an embodiment of the present disclosure.

Referring to FIG. 1, the electrified vehicle may include a DC charging/discharging terminal 110, an AC charging/discharging terminal 120, a motor drive system 200, a bidirectional power exchange device 300, and a battery 400, any of, any combination of, or all of which may be in plural or may include plural components thereof.

The DC charging/discharging terminal 110 may connect the electrified vehicle to an external device that uses DC power.

A first busbar 111 may be connected to the DC charging/discharging terminal 110 and the motor drive system 200. The external device using DC power and the battery 400 may exchange power through the DC charging/discharging terminal 110, the first busbar 111, and the motor drive system 200.

A second busbar 112 may be connected to the DC charging/discharging terminal 110 and the bidirectional power exchange device 300. The external device using DC power and the battery 400 may exchange power through the DC charging/discharging terminal 110, the second busbar 112, and the bidirectional power exchange device 300.

A DC power charging and discharging process in which the external device using DC power and the battery 400 exchange power through the first busbar 111 using the motor drive system 200 can be referred to herein as “first mode DC power conversion”, and a DC power charging and discharging process in which the external device using DC power and the battery 400 exchange power through the second busbar 112 using the bidirectional power exchange device 300 can be referred to herein as “second mode DC power conversion”.

The AC charging/discharging terminal 120 may connect the electrified vehicle to an external device that uses AC power. A process in which the external device using AC power can be connected to the AC charging/discharging terminal 120 and the external device and the battery 400 exchange power using the bidirectional power exchange device 300 can be referred to herein as “AC power conversion”. For example, the AC power conversion may include a charging process in which AC power is converted into DC power using the bidirectional power exchange device 300 and used to charge the battery 400, and a discharging process in which DC power of the battery 400 is converted into AC power and transmitted to the external device that uses AC power.

The motor drive system 200 may include an inverter (not illustrated) having a plurality of switches and a drive motor (not illustrated). The motor drive system 200 may be connected to the battery 400 to exchange power with the external device that uses DC power. For example, during the first mode DC power conversion, when a voltage (e.g., 400 V) of DC power received from the external device through the DC charging/discharging terminal 110 and the first busbar 111 is lower than a charging voltage (e.g., 800 V) of the battery 400, the motor drive system 200 may control the drive motor and the inverter based on a boost converter topology, thereby boosting the voltage of the received DC power to match the charging voltage of the battery 400.

The bidirectional power exchange device 300 can be also called a bidirectional on-board charger (OBC) and may include a power factor correction circuit 310 and a DC-DC converter 320. The bidirectional power exchange device 300 may be selectively connected to the DC charging/discharging terminal 110 or the AC charging/discharging terminal 120, and may perform bidirectional voltage control for power exchange between the connected charging/discharging terminal and the battery 400.

The power factor correction circuit 310 may include a plurality of switches.

When the external device using AC power is connected to the AC charging/discharging terminal 120, the plurality of switches included in the power factor correction circuit 310 may convert AC power into DC power or convert DC power into AC power. For example, when the external device using AC power is connected to the AC charging/discharging terminal 120, the power factor correction circuit 310 may be controlled to convert AC power applied from the external device into DC power, or to convert DC power applied from the battery 400 into AC power. The power factor correction circuit 310 may be controlled based on a totem pole topology or a push-pull topology.

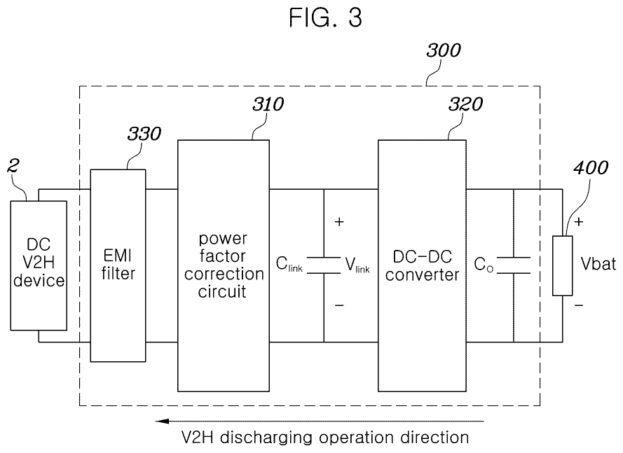

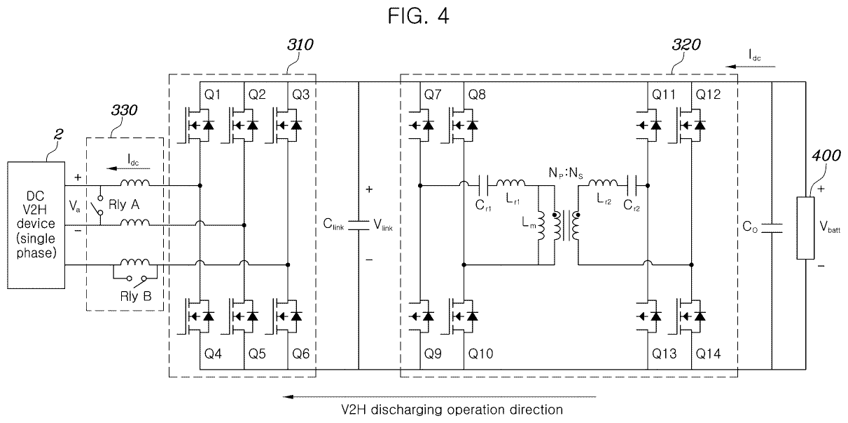

When the external device using DC power is connected to the DC charging/discharging terminal 110 and the second mode DC power conversion is performed, the plurality of switches included in the power factor correction circuit 310 may be controlled based on a buck converter topology or a boost converter topology. An example specific configuration of the power factor correction circuit 310 and the operation of the power factor correction circuit 310 when the second mode DC power conversion is performed will be described later with reference to FIGS. 3 and 4.

The DC-DC converter 320 may be connected to the power factor correction circuit 310 and the battery 400, and may control a voltage of power applied to the battery 400 or a voltage of power applied to the external devices. The DC-DC converter 320 may be implemented as a bidirectional LLC resonant converter including a plurality of switches, a plurality of capacitors, and a plurality of inductors.

The battery 400 may store power required for driving the electrified vehicle and exchanging power with the external devices.

When the external device using DC power is connected to the DC charging/discharging terminal 110, the controller 500 may control power exchange between the connected external device and the battery 400 through the motor drive system 200 based on the result of communication with the connected external device, or control power exchange between the connected external device and the battery 400 through the bidirectional power exchange device 300.

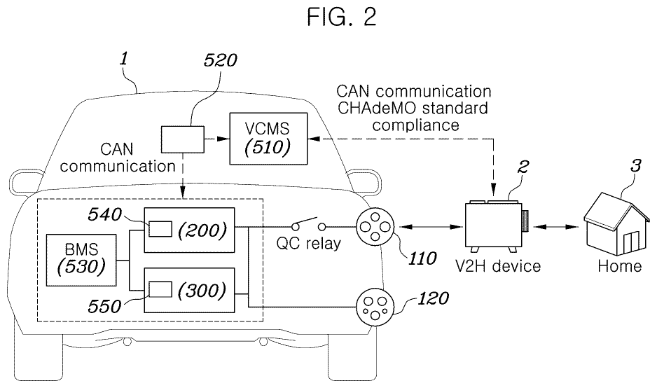

Hereinafter, the operation of the controller 500 in a situation where an external V2H device using DC power is connected will be described in more detail with reference to FIG. 2.

FIG. 2 is a view illustrating a process of transmitting a signal when a V2H device 2 using DC power is connected to a DC terminal, according to an embodiment of the present disclosure.

Referring to FIG. 2, there is illustrated a situation where an electrified vehicle 1 and the V2H device 2 are connected to perform power exchange between a home 3 and the electrified vehicle 1. The controller 500 may include a vehicle charging management system (VCMS) 510 that can manage voltage imbalance between a charger and a battery and adjust a charging voltage, a vehicle control unit (VCU) 520 that can control the entire vehicle and monitor a charging status, a battery management system (BMS) 530 that can manage a battery temperature, voltage, and current during charging, a motor control unit (MCU) 540 that can control the motor drive system 200, and an on-board charger (OBC) controller 550 that can control the bidirectional power exchange device 300.

The V2H device 2 may perform power exchange between the home 3 and the electrified vehicle 1. The V2H device 2 may be a device that performs DC power exchange between the V2H device 2 and the electrified vehicle 1 and power exchange between the V2H device 2 and the home 3 based on the CHAdeMO standard, for example, which is a Japanese charging standard.

The VCMS 510 may communicate with and exchange information with the V2H device 2 when the V2H device 2 is connected to the DC charging/discharging terminal 110 of the electrified vehicle 1. A communication method between VCMS 510 and the V2H device 2 may correspond to a controller area network (CAN) communication technique. The VCMS 510 may transmit voltage information, current information, or power information of the V2H device 2 received through communication with the V2H device 2 to the VCU 520.

The VCU 520 may determine, based on the result of communication with the V2H device 2, whether to perform the first mode DC power conversion in which the V2H device 2 and the battery 400 exchange power through control of the motor drive system 200 by the MCU 540, or whether to perform the second mode DC power conversion in which the V2H device 2 and the battery 400 exchange power through control of the bidirectional power exchange device 300 by the OBC controller 550. For example, the VCU 520 may determine whether to control the motor drive system 200 according to the first mode DC power conversion or whether to control the bidirectional power exchange device 300 according to the second mode DC power conversion based on whether the VCU 520 has received information from the V2H device 2 indicating that the connected external device is the V2H device 2.

The BMS 530 may obtain information from the motor drive system 200, the bidirectional power exchange device 300, and the battery 400, and transmit the obtained information to the VCU 520. For example, when performing second mode charging/discharging control, the BMS 530 may obtain information such as voltage, current, and temperature of a plurality of switching elements included in the motor drive system 200 and transmit the information to the VCU 520.

When the OBC controller 550 receives a second mode DC power conversion control command from the VCU 520, the OBC controller 550 may perform charging control to control the bidirectional power exchange device 300 so that power can be applied from the V2H device 2 to the battery 400, or discharging control to control the bidirectional power exchange device 300 so that power can be applied from the battery 400 to the V2H device 2.

Hereinafter, the operation of the bidirectional power exchange device 300 during the second mode DC power conversion will be described with reference to FIGS. 3 and 4.

FIGS. 3 and 4 are views illustrating a bidirectional power exchange device 300 according to an embodiment of the present disclosure.

Referring to FIGS. 3 and 4, the bidirectional power exchange device 300 may include a power factor correction circuit 310 including first to sixth switches Q1, Q2, Q3, Q4, Q5, and Q6, a bidirectional DC-DC converter 320 including seventh to tenth switches Q7, Q8, Q9, and Q10 and eleventh to fourteenth switches Q11, Q12, Q13, and Q14, an EMI filter 330 including first to third windings L1, L2, and L3, a first relay Rly A and a second relay Rly B, and a link capacitor Cₗᵢₙₖ, for example.

The second mode DC power conversion may include second mode charging in which power can be applied from the V2H device 2 connected to the electrified vehicle 1 to the battery 400 and second mode discharging in which power can be applied from the battery 400 to the V2H device 2.

During the second mode charging, power of the V2H device 2 may be applied to the battery 400 through the EMI filter 330, the power factor correction circuit 310, and the bidirectional DC-DC converter 320.

The power factor correction circuit 310 may boost a DC voltage of power output from the V2H device 2 and apply the voltage to the link capacitor Cₗᵢₙₖ. More in detail, the third switch Q3 of the power factor correction circuit 310 may be kept in an off state, the sixth switch Q6 may be kept in an on state, and both the first relay Rly A and the second relay Rly B of the EMI filter 330 may be kept in an off state, so the phase of a Cₗᵢₙₖ voltage may be maintained without changing. The first switch Q1, the second switch Q2, the fourth switch Q4, and the fifth switch Q6 of the power factor correction circuit 310 may be controlled based on a boost converter topology to boost the size of a DC voltage output to the link capacitor Cₗᵢₙₖ. The OBC controller 550 may control a duty ratio of a PWM signal transmitted to the first switch Q1, the second switch Q2, the fourth switch Q4, and the fifth switch Q5 to control the size of the DC voltage output to the link capacitor Cₗᵢₙₖ.

The bidirectional DC-DC converter 320 may re-boost the voltage of the link capacitor Cₗᵢₙₖ output from the power factor correction circuit 310 and apply power to the battery 400. The seventh to tenth switches Q7, Q8, Q9, and Q10 and the eleventh to fourteenth switches Q11, Q12, Q13, and Q14 of the bidirectional DC-DC converter 320 may be controlled based on a bidirectional LLC resonant circuit topology to apply boosted power to the battery 400.

During the second mode discharging, power of the battery 400 may be applied to the V2H device 2 through the bidirectional DC-DC converter 320, the power factor correction circuit 310, and the EMI filter 330.

The bidirectional DC-DC converter 320 may apply voltage-lowered power to the link capacitor Cₗᵢₙₖ. The seventh to tenth switches Q7, Q8, Q9, and Q10 and the eleventh to fourteenth switches Q11, Q12, Q13, and Q14 of the bidirectional DC-DC converter 320 may be controlled based on a bidirectional LLC resonant circuit topology to apply a lowered Cₗᵢₙₖ voltage to the link capacitor Cₗᵢₙₖ.

During the second mode discharging, the power factor correction circuit 310 may lower a Cₗᵢₙₖ voltage output from the bidirectional DC-DC converter 320 back to a DC voltage output to the V2H device 2. More in detail, the third switch Q3 of the power factor correction circuit 310 may be kept in an off state, the sixth switch Q6 may be kept in an on state, and both the first relay Rly A and the second relay Rly B of the EMI filter 330 may be kept in an off state, so the phase of a Cₗᵢₙₖ voltage may be maintained without changing. The first switch Q1, the second switch Q2, the fourth switch Q4, and the fifth switch Q6 of the power factor correction circuit 310 may be controlled based on a buck converter topology to lower the size of a DC voltage output to the EMI filter 330. The OBC controller 550 may control a duty ratio of a PWM signal transmitted to the first switch Q1, the second switch Q2, the fourth switch Q4, and the fifth switch Q5 so that the size of the DC voltage output to the EMI filter 330 corresponds to a voltage of the V2H device 2.

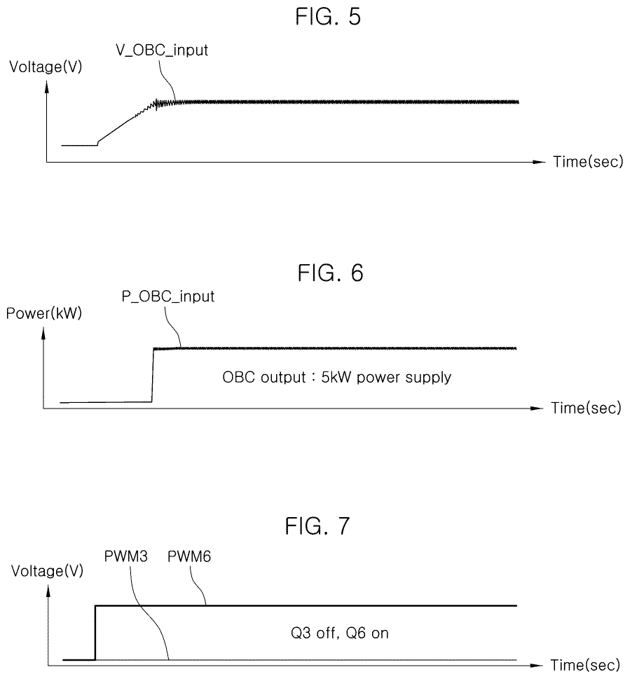

FIGS. 5 to 7 are graphs illustrating PWM signals, output voltage, and output power outputted by a third switch Q3 and a sixth switch Q6 during second mode DC power exchange according to an embodiment of the present disclosure.

Referring to FIG. 7, there is illustrated a voltage graph of an example PWM3 signal output to the third switch Q3 and an example PWM6 signal output to the sixth switch Q6 during the second mode DC power conversion that exchanges power using the bidirectional power exchange device 300.

At a time point when the second mode DC power conversion starts, the PWM3 signal can output to the third switch Q3 and may be maintained in an off state, while the PWM6 signal can output to the sixth switch Q6 and may be maintained in an on state.

Referring to FIG. 5, an input voltage input from the external V2H device 2 to the bidirectional power exchange device 300 after the start of the second mode DC power conversion may correspond to 400 V. Referring to FIG. 6, an input power input from the external V2H device 2 to the bidirectional power exchange device 300 after the start of the second mode DC power conversion may correspond to 5 kW.

When power is exchanged through the bidirectional power exchange device 300 with an external device using low power, such as the V2H device 2, compared to a case where power is exchanged through the motor drive system 200, a switching operation may be performed in a low power section, so a switching operation close to zero voltage switching (ZVS) and zero current switching (ZCS) may be performed, and in this process, switching loss may be greatly reduced.

More in detail, when power exchange is performed between the V2H device 2 using 5 kW to 10 kW power and the battery 400 through the motor drive system 200 designed with 300 kW power, power conversion efficiency may be only about 50%.

On the other hand, when power exchange is performed between the V2H device 2 and the battery 400 through the bidirectional power exchange device 300, power conversion efficiency may be about 90% or more, so the efficiency may be improved by about 40% or more compared to when power conversion is performed through the conventional motor drive system 200.

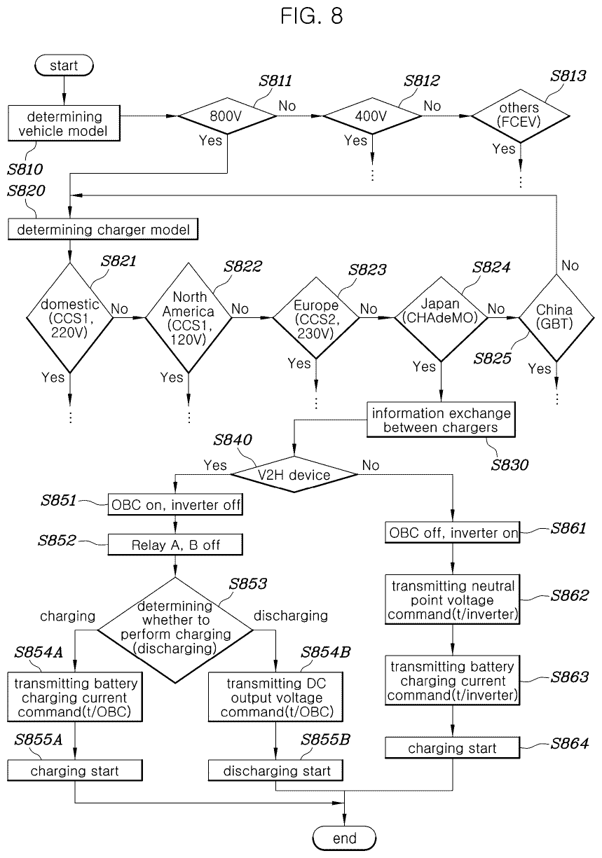

Hereinafter, a more specific control process when the V2H device 2 using 5 kW to 10 kW power is connected to the electrified vehicle 1 will be described with reference to FIG. 8.

FIG. 8 is a flowchart illustrating an example process of controlling an electrified vehicle according to an embodiment of the present disclosure.

Referring to FIG. 8, when an external device is connected to an electrified vehicle, the controller 500 may determine an electrified vehicle model (operation S810). The controller 500 may determine whether the electrified vehicle is an 800V model, a 400V model, or other models based on a pre-stored setting value corresponding to the electrified vehicle model.

When it is determined that the electrified vehicle is not a model using an 800V battery (No in operation S811), the controller 500 may determine whether the electrified vehicle is a model using a 400V battery (operation S812) and whether the electrified vehicle is an FCEV model (operation S813). However, the above-described method for determining the electrified vehicle model is an example, and the present disclosure is not necessarily limited thereto. For example, the controller 500 may be designed to determine the electrified vehicle model based on other information such as voltage of the battery 400, or to change the order of determining whether which model the vehicle corresponds to.

When it is determined that the electrified vehicle is a model using an 800V battery (Yes in operation S811), the controller 500 may determine an external device model connected to the electrified vehicle (operation S820).

In detail, a charger model may be determined by whether it corresponds to a domestic model (e.g., CCS1 or 220V) (operation S821), a North American model (e.g., CCS1 or 120V) (operation S822), a European model (e.g., CCS2 or 230V) (operation S823), a Japanese model (e.g., CHAdeMO) (operation S824), and other models (e.g., China (GBT)) (operation S825). The controller 500 may determine the charger model based on whether a charging/discharging terminal to which the external device is connected corresponds to a charging/discharging terminal corresponding to each model.

When it is determined that the external device is a Japanese model (e.g., CHAdeMO) (Yes in operation S824), for example, the controller 500 may communicate with the external device to exchange information (operation S830), and determine whether the external device is a V2H device 2 based on the result of communication with the external device (operation S840). The V2H device 2 may transmit information that the external device corresponds to the V2H device 2 to the controller 500 through CAN communication, and the controller 500 may determine whether the connected external device corresponds to the V2H device 2 based on the CAN communication result. The result of communication with the external device may include information such as whether the device is the V2H device 2 and voltage and current output from the external device.

When it is determined that the external device is the V2H device 2 (Yes in operation S840), the controller 500 may turn on the bidirectional power exchange device 300 and keep the inverter of the motor drive system 200 in an off state (operation S851). The controller 500 may control the first relay Rly A and the second relay Rly B included in the EMI filter 330 to be kept in an off state (operation S852).

The controller 500 may determine whether to perform a charging mode or a discharging mode (operation S853). Whether to perform the charging mode or the discharging mode may be determined based on whether a current is applied from the V2H device 2 to the battery 400 or from the battery 400 to the V2H device 2.

When it is determined to perform the charging mode (Charging in operation S853), the VCU of the controller 500 may transmit a charging current command for the battery 400 to the OBC controller of the bidirectional power exchange device 300 (operation S854A), and the OBC controller may start controlling the bidirectional power exchange device 300 to charge the battery 400 based on the received charging current command (operation S855A). The OBC controller may control the plurality of switches included in the power factor correction circuit 310 based on a boost converter topology that boosts a voltage of power applied from the external device.

On the other hand, when it is determined to perform the discharging mode (Discharging in operation S853), the VCU of the controller 500 may transmit a DC output voltage command to the OBC controller of the bidirectional power exchange device 300 (operation S854B), and the OBC controller may start discharging control (operation S855B) to apply power from the battery 400 to the external device based on the received DC output voltage command. The OBC controller may control the plurality of switches included in the power factor correction circuit 310 based on a buck converter topology that lowers a voltage of power applied from the battery 400.

When it is determined that the external device is not the V2H device 2 (No in operation S840), the controller 500 may keep the bidirectional power exchange device 300 in an off state and turn on the inverter of the motor drive system 200 (operation S861). The VCU of the controller 500 may transmit a neutral point voltage command (operation S862) and a charging current command for the battery 400 to the MCU that controls the inverter of the motor drive system 200 (operation S863), and the MCU may start controlling the motor drive system 200 to perform charging of the battery 400 based on the received neutral point voltage command and the charging current command for the battery 400 (operation S864).

Through the electrified vehicle and a control method thereof according to an embodiment of the present disclosure, power conversion of the V2H device and the electrified vehicle may be performed using the configuration of the bidirectional power exchange device.

Through the electrified vehicle and a control method thereof according to an embodiment of the present disclosure, power conversion efficiency may be greatly increased compared to power conversion using a conventional motor drive system, while minimizing additional components in the configuration of a conventional electrified vehicle.

An embodiment of the present disclosure described above can be implemented in a program recorded medium as computer-readable codes. The computer-readable media can include all kinds of recording devices in which data readable by a computer system are stored, such as hard disk drives (HDDs), solid state disks (SSDs), silicon disk drives (SDDs), ROM, RAM, CD-ROMs, magnetic tapes, floppy disks, optical data storage devices, and the like, for example. The above example embodiments are therefore to be construed as illustrative and not necessarily restrictive. The scopes of the present disclosure can be determined by the appended claims and their legal equivalents and all changes coming within the meaning and equivalency range of the appended claims can be intended to be embraced therein.

What is claimed is:

1. A vehicle, comprising:
a battery;
a DC charging/discharging terminal and an AC charging/discharging terminal configured to be electrically connected to an external device;
a motor drive system comprising an electric drive motor and an inverter;
a bidirectional power exchange device configured to be selectively connected to a connected charging/discharging terminal selected from the DC charging/discharging terminal and the AC charging/discharging terminal, and configured to perform bidirectional voltage conversion control for power exchange between the connected charging/discharging terminal and the battery; and
a controller configured to perform, in response to the external device being one using DC power and being connected to the DC charging/discharging terminal, power exchange between the external device and the battery through the motor drive system or power exchange between the external device and the battery through the bidirectional power exchange device, based on a result of communication with the external device.

2. The vehicle of claim 1, wherein the bidirectional power exchange device comprises:
a power factor correction circuit comprising a plurality of power-factor-correction-circuit switches; and
a DC-DC converter comprising a plurality of DC-DC-converter switches.

3. The vehicle of claim 2, wherein the controller is configured to perform the power exchange between the external device and the battery through the bidirectional power exchange device in such a manner that,
in response to power being applied to the battery from the external device, the controller is configured to control the power factor correction circuit based on a boost converter topology that is configured to boost a first voltage of power applied from the external device, and
in response to power being applied from the battery to the external device, the controller is configured to control the power factor correction circuit based on a buck converter topology that is configured to lower a second voltage of power applied from the battery.

4. The vehicle of claim 2, wherein the DC-DC converter is a bidirectional LLC resonant converter.

5. The vehicle of claim 2, wherein, in response to the external device being connected to the AC charging/discharging terminal and AC power being applied from the external device to the battery, the controller is configured to control the power factor correction circuit to convert applied AC power into DC power, and
wherein, in response to the external device being connected to the AC charging/discharging terminal and DC power being applied from the battery to the external device, the controller is configured to control the power factor correction circuit to convert DC power applied from the battery into AC power.

6. The vehicle of claim 5, wherein, in response to the external device being connected to the AC charging/discharging terminal, the controller being configured to control the power factor correction circuit based on a totem pole topology or a push-pull topology.

7. The vehicle of claim 1, wherein, in response to the power exchange between the external device and the battery being performed through the motor drive system, the controller is configured to keep the bidirectional power exchange device in an off state.

8. The vehicle of claim 1, wherein, in response to the power exchange between the external device and the battery being performed through the bidirectional power exchange device, the controller is configured to keep the inverter of the motor drive system in an off state.

9. The vehicle of claim 1, wherein, in response to it being determined that the external device is a vehicle-to-home (V2H) device, the controller is configured to perform the power exchange between the external device and the battery through the bidirectional power exchange device.

10. The vehicle of claim 1, wherein the DC charging/discharging terminal comprises a busbar configured to connect the DC charging/discharging terminal and the bidirectional power exchange device.

11. A control method of a vehicle, the control method comprising:
determining whether an external device using DC power is connected to a DC charging/discharging terminal of the vehicle among the DC charging/discharging terminal and an AC charging/discharging terminal of the vehicle that are configured to be electrically connected to the external device;
communicating, by a controller of the vehicle, with the external device in response to the external device being connected to the DC charging/discharging terminal; and
performing, under control of the controller, power exchange between the external device and a battery of the vehicle through a motor drive system or power exchange between the external device and the battery through a bidirectional power exchange device, based on the communicating with the external device.

12. The method of claim 11, wherein the bidirectional power exchange device comprises:
a power factor correction circuit comprising a plurality of power-factor-correction-circuit switches; and
a DC-DC converter comprising a plurality of DC-DC-converter switches.

13. The method of claim 12, wherein in the performing of the power exchange between the external device and the battery through the bidirectional power exchange device,
in response to power being applied to the battery from the external device, the controller controls the power factor correction circuit based on a boost converter topology that boosts a first voltage of power applied from the external device, and
in response to power being applied from the battery to the external device, the controller controls the power factor correction circuit based on a buck converter topology that lowers a second voltage of power applied from the battery.

14. The method of claim 12, wherein the DC-DC converter is a bidirectional LLC resonant converter.

15. The method of claim 12, further comprising:
determining whether the external device is connected to the AC charging/discharging terminal; and
performing, under control of the controller, AC power exchange between the external device and the battery through the bidirectional power exchange device based on the communicating with the external device,
wherein in the performing of the AC power exchange between the external device and the battery,
in response to AC power being applied from the external device to the battery through the AC charging/discharging terminal, the controller controls the power factor correction circuit to convert applied AC power into DC power, and
in response to DC power being applied from the battery to the external device, the controller controls the power factor correction circuit to convert DC power applied from the battery into AC power.

16. The method of claim 15, wherein the performing of the AC power exchange between the external device and the battery comprises controlling, by the controller, the power factor correction circuit based on a totem pole topology or a push-pull topology.

17. The method of claim 11, wherein the performing of the power exchange between the external device and the battery through the motor drive system further comprises keeping, by the controller, the bidirectional power exchange device in an off state.

18. The method of claim 11, wherein the performing of the power exchange between the external device and the battery through the bidirectional power exchange device further comprises keeping, by the controller, an inverter of the motor drive system in an off state.

19. The method of claim 11, wherein, in response to it being determined that the external device is a vehicle-to-home (V2H) device based on the communicating with the external device, the performing of the power exchange is between the external device and the battery through the bidirectional power exchange device.

20. The method of claim 11, wherein the DC charging/discharging terminal comprises a busbar configured to connect the DC charging/discharging terminal and the bidirectional power exchange device.
